(19) United States
(12) Patent Application Publication
(10) Pub. No.: US 2020/0042359 A1
(43) Pub. Date: Feb. 6, 2020

(54) SYSTEMS AND METHODS FOR COMPUTING RESOURCES ALLOCATION FOR MEDICAL APPLICATIONS

(71) Applicant: SHANGHAI UNITED IMAGING HEALTHCARE CO., LTD., Shanghai (CN)

(72) Inventors: Zhiguo ZHANG, Shanghai (CN); Chunshan YANG, Shanghai (CN)

(73) Assignee: SHANGHAI UNITED IMAGING HEALTHCARE CO., LTD., Shanghai (CN)

(21) Appl. No.: 16/236,584

(22) Filed: Dec. 30, 2018

Related U.S. Application Data
(63) Continuation of application No. PCT/CN2018/098568, filed on Aug. 3, 2018.

(51) Int. Cl. G06F 9/50

(52) U.S. Cl. CPC G06F 9/5038; G06F 9/5083; G06F 9/5055

(57) ABSTRACT

A method may include receiving requests for performing the medical applications from at least one client terminal via a user interface. Each of the medical applications may have a priority. The method may also include identifying, from the medical applications, a first medical application whose priority satisfies a condition and determining a first criterion associated with the first medical application indicating an estimated computing resource that the first medical application demands. The method may also include determining a second criterion associated with each of the plurality of computing devices indicating a characteristic of the each of the plurality of computing devices. The method may further include identifying a first computing device from the plurality of computing devices based on the first criterion and the second criterion, and allocating the first computing device to execute the first medical application.

### CROSS-REFERENCE TO RELATED APPLICATIONS

This application is a Continuation of International Application No. PCT/CN2018/098568, filed on Aug. 3, 2018, the contents of which is incorporated herein by reference.

### TECHNICAL FIELD

The disclosure generally relates to computing resources management, and more particularly relates to systems and methods for allocating computing resources for medical applications.

### BACKGROUND

Medical centers such as hospitals and medical imaging centers generally have multiple medical imaging devices such as CT, MR, PET, and other imaging devices. In some embodiments, an imaging device may be configured to perform medical applications relating to, such as 3D image rendering for display, image reconstruction, etc. In some embodiments, a medical center may generally have multiple workstations to perform medical application such as image post-processing (e.g., 3D image rendering).

The various medical applications executed by a medical device or a workstation may demand high computing power/computing resources to perform the medical applications smoothly. For this purpose, one or more graphics/high-performance processors with strong computing power may generally be deployed in the computing device host of the medical device. Computing resources of the computing device may generally be allocated to a single medical device or even a single medical application. To avoid resource waste and cost savings, it is desired to provide systems and methods for allocating computing resources for medical applications effectively.

### SUMMARY

In a first aspect of the present disclosure, a system for allocating computing resources for medical applications is provided. The system may include a plurality of computing devices, a network, at least one storage device, and one or more resource managers. Each of the plurality of computing devices may include at least one processor. The network may be configured to facilitate communication between components in the system. The at least one storage device may store executable instructions. The one or more resource managers may be configured to communicate with the plurality of computing devices and the at least one storage device via the network, when executing the executable instructions, the system may be configured to perform one or more of the following operations. Requests for performing the medical applications may be received from at least one client terminal via the user interface, each of the medical applications may have a priority. A first medical application whose priority satisfies a condition may be identified from the medical applications. A first criterion associated with the first medical application may be determined. The first criterion may indicate an estimated computing resource that the first medical application demands. A second criterion associated with each of the plurality of computing devices may be determined. The second criterion may indicate a characteristic of the each of the plurality of computing devices. A first computing device may be identified from the plurality of computing devices based on the first criterion and the second criterion. The first computing device may be allocated to execute the first medical application.

In some embodiments, the medical applications may include at least one of an image reconstruction application, an image post-processing application, a volume rendering application, a virtual reality application, or an artificial intelligence application.

In some embodiments, the estimated computing resource that the first medical application demands may be defined by at least one of an estimated storage volume the first medical application occupies, a type of a computing device executing the first medical application, or a computing capability of the computing device.

In some embodiments, the system may be further configured to perform one or more of the following operations. One portion of a computing resource of the first computing device for the first medical application may be reserved. The one portion of the computing resource of the first computing device may be greater than or equal to the estimated computing resource that the first medical application demands. The one portion of the computing resource of the first computing device allocated to the first medical application may be recorded. The one portion of the computing resource of the first computing device may be released when the first computing device finishes executing the first medical application.

In some embodiments, the system may be further configured to perform one or more of the following operations. A free computing resource of the first computing device may be identified based on the estimated computing resource that the first medical application demands and/or the portion of the computing resource of the first computing device reserved for the first medical application. The identified free computing resource may be recorded.

In some embodiments, the system may be further configured to perform one or more of the following operations. The first computing device may be determined from the plurality of computing devices by determining whether the first medical application is similar to or associated with a second medical application executed by a second computing device.

In some embodiments, the system may be further configured to perform one or more of the following operations. Whether the first medical application is similar to or associated with the second medical application may be determined. In response to the determination that the first medical application is similar to or associated with the second medical application, whether the second criterion of the second computing device satisfies the first criterion associated with the first medical application may be determined. In response to a determination that the second criterion of the second computing device satisfies the first criterion associated with the first medical application, the second computing device may be designated as the first computing device.

In some embodiments, the system may be further configured to perform one or more of the following operations. That the first medical application is not similar to or associated with the second medical application may be determined. One or more third computing devices may be identified from the plurality of computing devices. The second criterion of each of the one or more third computing devices may satisfy the first criterion associated with the first medical application. A third computing device having a maximum free computing resource among the one or more third computing devices may be designated as the first computing device.

In some embodiments, the system may be further configured to perform one or more of the following operations. That the second criterion of the each of the plurality of computing devices does not satisfy the first criterion associated with the first medical application may be determined. A third medical application allocated to a fourth computing device may be determined. A priority of the third medical application may be lower than the priority of the first medical application. A computing resource of the fourth computing device reserved for or occupied by the third medical application may be released. The fourth computing device may be designated as the first computing device.

In some embodiments, the system may be further configured to perform one or more of the following operations. That the second criterion of the each of plurality of computing devices does not satisfy the first criterion associated with the first medical application may be determined. The first medical application may be divided into a plurality of tasks. The plurality of tasks may be allocated to at least one of the plurality of computing devices.

In some embodiments, the system may be further configured to perform one or more of the following operations. A fourth medical application whose priority is the same as or similar to the first medical application may be determined. That a queue time of the first medical application is longer than that of the fourth medical application or the estimated computing resource of the first medical application is lower than that of the fourth medical application may be determined.

In some embodiments, the system may be further configured to perform one or more of the following operations. The first computing device may execute the first medical application to generate a result. The result associated with the first medical application may be sent to the at least one client terminal.

In some embodiments, the each of the plurality of computing devices may include one or more computing cards.

In some embodiments, the one or more resource managers may include a network load balancer configured to receive and allocate the requests to the one or more resource managers.

In some embodiments, the system may be further configured to perform one or more of the following operations. One or more characteristics of the first medical application may be received from the at least one client terminal via the user interface.

In some embodiments, the system may be further configured to perform one or more of the following operations. A notification that a computing device has been allocated to execute the first medical application may be provided to the at least one client terminal via the user interface.

In a second aspect of the present disclosure, a method for allocating computing resources for medical applications is provided. The method may be implemented on a computing device including at least one processor and a storage device. The method may include one or more of the following operations. Requests for performing the medical applications may be received from at least one client terminal via the user interface, each of the medical applications may have a priority. A first medical application whose priority satisfies a condition may be identified from the medical applications. A first criterion associated with the first medical application may be determined. The first criterion may indicate an estimated computing resource that the first medical application demands. A second criterion associated with each of the plurality of computing devices may be determined. The second criterion may indicate a characteristic of the each of the plurality of computing devices. A first computing device may be identified from the plurality of computing devices based on the first criterion and the second criterion. The first computing device may be allocated to execute the first medical application.

In a third aspect of the present disclosure, a non-transitory computer readable medium may store instructions, the instructions, when executed by a computing device, the computing device may be configured to perform one or more of the following operations. Requests for performing the medical applications may be received from at least one client terminal via the user interface, each of the medical applications may have a priority. A first medical application whose priority satisfies a condition may be identified from the medical applications. A first criterion associated with the first medical application may be determined. The first criterion may indicate an estimated computing resource that the first medical application demands. A second criterion associated with each of the plurality of computing devices may be determined. The second criterion may indicate a characteristic of the each of the plurality of computing devices. A first computing device may be identified from the plurality of computing devices based on the first criterion and the second criterion. The first computing device may be allocated to execute the first medical application.

In a fourth aspect of the present disclosure, a method for allocating computing resources for medical applications is provided. The method may be implemented by a computing system. The computing system may include a plurality of computing nodes. The method may include one or more of the following operations. One or more requests for performing the medical applications may be received from at least one client terminal via a user interface by the computing system. Each of the medical applications may have a priority. One or more computing nodes for the at least one of the medical applications whose priority satisfies a condition may be determined based on a task property of at least one of the medical applications. The one or more determined computing nodes may execute the at least one of medical applications.

In some embodiments, the method may further include one or more of the following operations. An estimated computing resource that the at least one of the medical applications demands may be evaluated based on the task property, wherein the task property may include at least one of an estimated storage volume the at least one of the medical applications occupies, a type of the one or more computing nodes executing the at least one of the medical applications, a computing capability of the one or more computing nodes, or a task affinity. That the one or more computing nodes whose computing resource matches with the estimated computing resource may be determined.

In some embodiments, the medical applications may include at least one of an image reconstruction application, an image post-processing application, a volume rendering application, a virtual reality application, or an artificial intelligence application.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary medical system according to some embodiments of the present disclosure;

FIG. 2A is a schematic diagram illustrating an exemplary computing cluster that the processing device 120 can be implemented according to some embodiments of the present disclosure;

FIG. 2B is a schematic diagram illustrating another exemplary computing cluster that the processing engine can be implemented according to some embodiments of the present disclosure;

FIG. 3 is a schematic diagram illustrating an exemplary computing device on which the medical system can be implemented according to some embodiments of the present disclosure;

FIG. 4 is a schematic diagram illustrating exemplary hardware and/or software components of an exemplary mobile device on which the terminal(s) may be implemented according to some embodiments of the present disclosure;

FIG. 5 is a block diagram illustrating an exemplary resource manager according to some embodiments of the present disclosure;

FIG. 6 a flowchart illustrating an exemplary process of allocating computing resources for medical applications in response to requests for performing the medical applications according to some embodiments of the present disclosure;

FIG. 7A and FIG. 7B are flowcharts illustrating another exemplary process of allocating computing resources for medical applications in response to requests for performing the medical applications according to some embodiments of the present disclosure; and

FIGS. 8A-8E are schematic diagrams illustrating exemplary task processing processes of a computing cluster on which the medical system 100 can be implemented according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, section or assembly of different level in ascending order. However, the terms may be displaced by another expression if they achieve the same purpose.

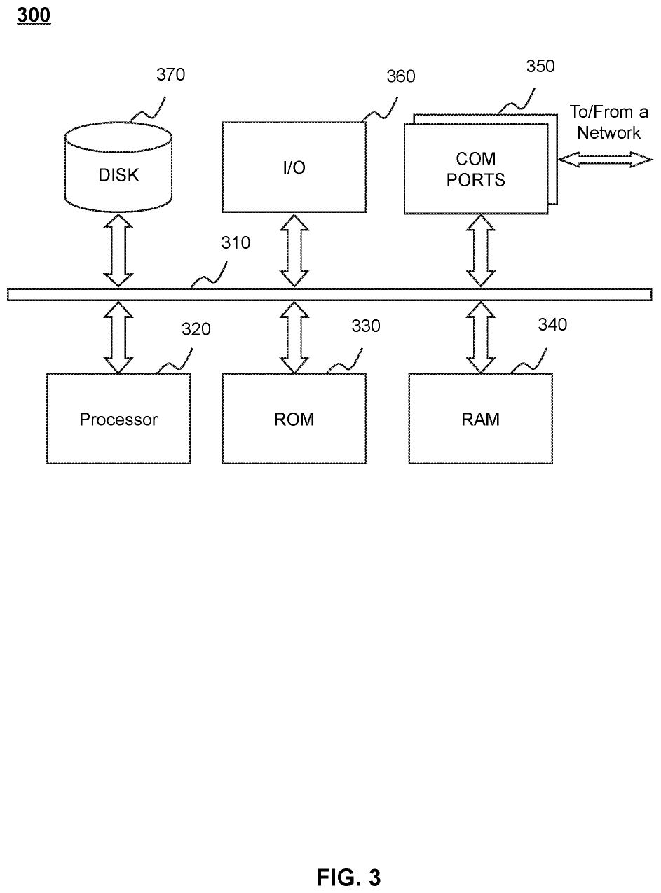

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processing unit 320 as illustrated in FIG. 3) may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included of connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Provided herein are systems and components for computing resources allocation to execute medical applications in a medical system. The medical system may find its applications in different fields such as disease diagnostic, physical check-up, or disease treatment. For example, the medical system may be used in an internal inspection (e.g., a non-invasive internal inspection) including, for example, tumor metabolism, brain function, heart function, or the like, or any combination thereof.

The following description is provided to help better understanding allocating computing resources for medical applications in response to requests for performing the medical applications received by interacting with at least one client terminal. The system may include a plurality of computing devices, one or more resource managers, and at least one storage device storing executable instructions. After receiving the requests for performing the medical applications from the at least one client terminal, a resource manager may identify a first medical application whose priority satisfies a condition from the medical applications. The resource manager may determine estimated computing resources that the first medical application demands. Further, the resource manager may determine a computing device from the plurality of computing devices based on the estimated computing resources that the first medical application demands and free computing resources of a computing device. The system may allocate computing devices based on real-time requests for performing medical applications, the priorities of the medical applications, and available computing devices. The system may also release a computing device when the medical application(s) performed by the computing device is finished or make a real-time adjustment to the computing device allocation so that another medical application may be performed by the computing device, in order to optimize computing device allocation and/or streamline the performance of medical applications. For instance, the system may pause or terminate the performance of a first medical application on a computing device so that the computing device may perform a second medical application that is more urgent and/or consumes less time than the first medical application. Accordingly, the system may improve usage efficiency of the plurality of computing devices, reduce idle time of the computing devices and wait time of the performance of medical applications, and allow timely performance of medical applications.

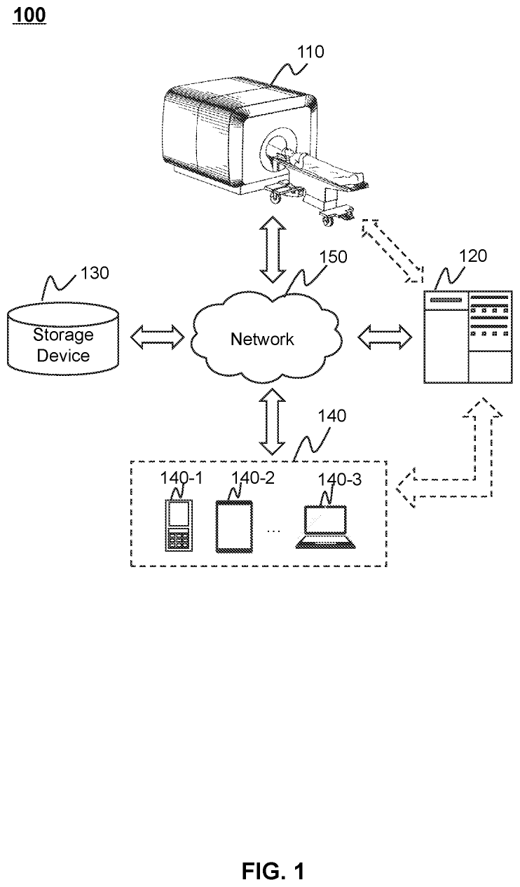

FIG. 1 is a schematic diagram illustrating an exemplary medical system 100 according to some embodiments of the present disclosure. In some embodiments, the medical system 100 may be a single-modality system or a multi-modality system. Exemplary single-modality systems may include a computed tomography (CT) system, a digital radiography (DR) system, a positron emission tomography (PET) system, a magnetic resonance (MR) system, a radiation therapy (RT) system, etc. Exemplary multi-modality systems may include a computed tomography-positron emission tomography (CT-PET) system, a magnetic resonance-positron emission tomography (MR-PET) system, etc. In some embodiments, the medical system 100 may include modules and/or components for performing imaging and/or related analysis.

Merely by way of example, as illustrated in FIG. 1, the medical system 100 may include a medical device 110, a processing device 120, a storage device 130, one or more terminals 140, and a network 150. The components in the medical system 100 may be connected in one or more of various ways. Merely by way of example, the medical device 110 may be connected to the processing device 120 through the network 150. As another example, the medical device 110 may be connected to the processing device 120 directly as illustrated in FIG. 1. As a further example, one or more terminals 140 may be connected to another component of the medical system 100 (e.g., the processing device 120) via the network 150. As still a further example, at least one terminal 140 may be connected to the processing device 120 directly as illustrated by the dotted arrow in FIG. 1. As still a further example, the storage device 130 may be connected to another component of the medical system 100 (e.g., the processing device 120) directly as illustrated in FIG. 1, or through the network 150.

The medical device 110 may include an imaging device, an interventional medical device, or a combination thereof. The imaging device may acquire image data relating to at least one part of a subject. The imaging data relating to at least one part of a subject may include an image (e.g., an image slice), projection data, or a combination thereof. In some embodiments, the imaging data may be a two-dimensional (2D) imaging data, a three-dimensional (3D) imaging data, a four-dimensional (4D) imaging data, or the like, or any combination thereof. The subject may be biological or non-biological. For example, the subject may include a patient, a man-made object, etc. As another example, the subject may include a specific portion, organ, and/or tissue of the patient. For example, the subject may include the head, the neck, the thorax, the heart, the stomach, a blood vessel, soft tissue, a tumor, nodules, or the like, or any combination thereof. Exemplary imaging devices may include a PET scanner, a CT scanner, a DR scanner, or the like, or a combination thereof. Exemplary interventional medical devices may include a radiation therapy (RT) device, an ultrasound treatment device, a thermal treatment device, a surgical intervention device, or the like, or a combination thereof.

The processing device 120 may process data and/or information obtained from the medical device 110, the terminal(s) 140, and/or the storage device 130. For example, the processing device 120 may execute one or more medical applications by processing image data acquired by the medical device 110. Exemplary medical applications may include an image reconstruction application, an image post-processing application, a volume rendering application, a virtual reality application, an artificial intelligence application, etc. The image reconstruction application may include a two-dimension reconstruction application, a three-dimension reconstruction application, etc. The image post-processing application may include an image denoising application, an image enhancement application, an image segmentation application, an image classification application, an image transformation application, an image registration application, etc. The virtual reality application may include an augmented reality rendering application, a mixed reality rendering application, etc. The artificial intelligence application may include an intelligent patient positioning application, an intelligent scanning planning application, an intelligent imaging quality optimization application, an intelligent image quality control application, etc., based on a machine learning technique.

In some embodiments, the processing device 120 may execute a medical application based on one or more algorithms and/or models corresponding to the medical application. For example, the processing device 120 may reconstruct images (e.g., a 2D image, a 3D image, etc.) based on an image reconstruction algorithm. As another example, the processing device 120 may perform a 3D rendering operation based on reconstructed images using a volume rendering algorithm, for example, a ray casting algorithm, a ray tracing algorithm, a marching cubes algorithm, etc.

In some embodiments, the processing device 120 may be a computer, a user console, a single server or a server group, etc. The server group may be centralized or distributed. In some embodiments, the processing device 120 may be local or remote. For example, the processing device 120 may access information and/or data stored in the medical device 110, the terminal(s) 140, and/or the storage device 130 via the network 150. As another example, the processing device 120 may be directly connected to the medical device 110, the terminal(s) 140 and/or the storage device 130 to access stored information and/or data. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

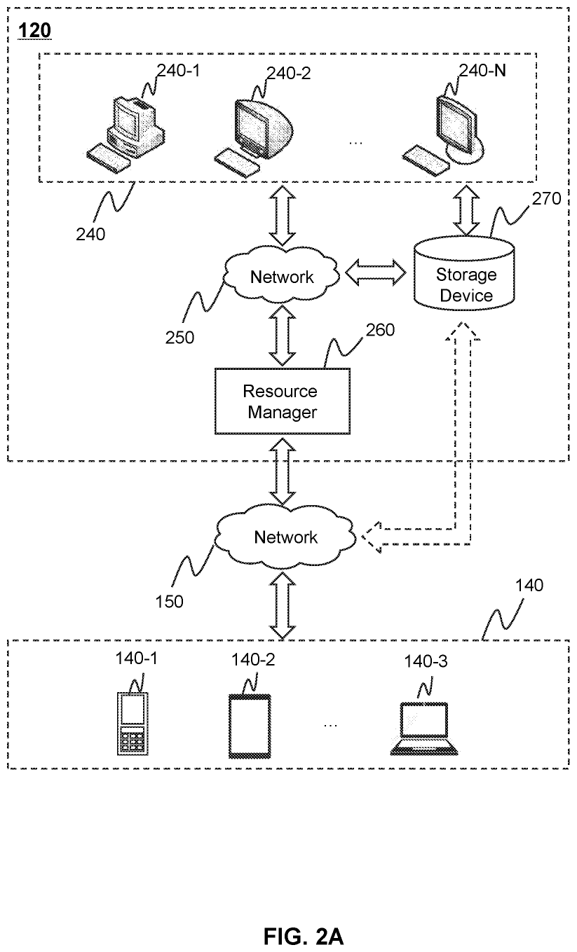

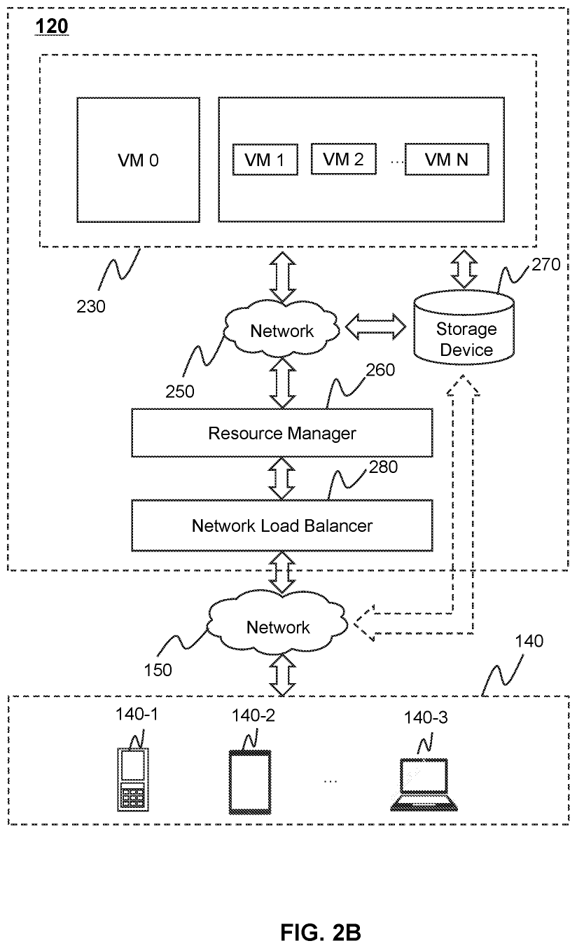

In some embodiments, the processing device 120 may include a computing cluster having a plurality of computing devices/computing components. Each of the plurality of computing devices may include at least one processor and at least one first storage device. The processing device 120 may further include one or more resource managers and at least one second storage device storing executable instructions. Each of the one or more resource managers may be configured to allocate the plurality of computing devices to execute medical applications (e.g., an image reconstruction application, an image post-processing application, a volume rendering application, etc.) in response to requests for performing the medical applications. In some embodiments, the processing device 120 may be implemented on a computing device 300 having one or more components as illustrated in FIG. 3. More detailed descriptions for the processing device 120 may be found elsewhere in the present disclosure (e.g., FIG. 2A, FIG. 2B, and descriptions thereof).

The storage device 130 may store data, instructions, and/or any other information. In some embodiments, the storage device 130 may store data obtained from the terminal(s) 140 and/or the processing device 120. The data may include image data acquired by the processing device 120, algorithms and/or models for processing the image data, information relating to components of the processing device 120, etc. For example, the storage device 130 may store image data acquired by the medical device 110. As another example, the storage device 130 may store one or more algorithms for processing the image data. As a still an example, the storage device 130 may store information relating to the plurality of computing devices in the processing device 120. In some embodiments, the storage device 130 may store data and/or instructions that the processing device 120 may execute or use to perform exemplary methods/systems described in the present disclosure. In some embodiments, the storage device 130 may include mass storage, removable storage, volatile read-and-write memory, read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components in the medical system 100 (e.g., the processing device 120, the terminal(s) 140, etc.). One or more components in the medical system 100 may access the data or instructions stored in the storage device 130 via the network 150. In some embodiments, the storage device 130 may be directly connected to or communicate with one or more other components in the medical system 100 (e.g., the processing device 120, the terminal(s) 140, etc.). In some embodiments, the storage device 130 may be part of the processing device 120.

The terminal(s) 140 may include a mobile device 140-1, a tablet computer 140-2, a laptop computer 140-3, or the like, or any combination thereof. In some embodiments, the mobile device 140-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, a footgear, eyeglasses, a helmet, a watch, clothing, a backpack, a smart accessory, or the like, or any combination thereof. In some embodiments, the mobile device may include a mobile phone, a personal digital assistant (PDA), a gaming device, a navigation device, a point of sale (POS) device, a laptop, a tablet computer, a desktop, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal(s) 140 may be part of the processing device 120.

In some embodiments, the terminal(s) 140 may send and/or receive information relating to a medical application to the processing device 120 via a user interface. In some embodiments, the user interface may be in form of an application for a medical application implemented on the terminal(s) 140. The user interface may be configured to facilitate communication between the terminal(s) 140 and a user associated with the terminal(s) 140. In some embodiments, the user interface may receive an input of a request for performing a medical application from the user through, for example, a user interface screen. The terminal(s) 140 may send the request for performing the medical application to the processing device 120 via the user interface for allocating computing resources for the medical device. The processing device 120 may determine one or more computing devices (nodes) for the medical device based on a task property of the medical device. The request for performing the medical application may include a computing protocol, raw data to be processed corresponding to the medical application, algorithms for processing the raw data, etc. The computing protocol may be used by the computing device to execute the medical application. For example, the computing protocol may be used to cause the computing device to obtain the raw data from the storage device 130. In some embodiments, the user may input and/or adjust the computing protocol, a task property of the medical application, a load balancing algorithm or a strategy, algorithms for processing the raw data, etc., via the user interface. For example, the user may input or adjust one or more information relating to one or more characteristics of the medical application (i.e., task property of the medical device) and/or a load balancing algorithm by inputting a command via the user interface. The terminal(s) 140 may send the information relating to one or more characteristics of the medical application and/or the load balancing algorithm as described elsewhere in the present disclosure to the processing device 120 via the user interface. Then processing device 120 may determine one or more computing devices (nodes) for executing the medical device based on the inputted or adjusted task properties of the medical device using the load balancing algorithm.

In some embodiments, the user interface may receive a signal relating to a medical application from the processing device 120. The signal may include a result generated after a computing device performs the medical application. For example, the result of the medical application may include one or more images (e.g., 2D images, 3D images, etc.), one or more data figures, one or more words, one or more digits, one or more models for performing the first medical application, one or more data tables, etc. In some embodiments, the signal may be further configured to cause the terminal(s) 140 to display the result to the user.

The network 150 may include any suitable network that can facilitate the exchange of information and/or data for the medical system 100. In some embodiments, one or more components of the medical device 110 (e.g., a CT scanner, a PET scanner, etc.), the one or more terminals 140, the processing device 120, the storage device 130, etc., may communicate information and/or data with one or more other components of the medical system 100 via the network 150. For example, the processing device 120 may obtain data from the medical device 110 via the network 150. As another example, the processing device 120 may obtain user instructions from the terminal 140 via the network 150. The network 150 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (“VPN”), a satellite network, a telephone network, routers, hubs, switches, server computers, and/or any combination thereof. Merely by way of example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the medical system 100 may be connected to the network 150 to exchange data and/or information. In some embodiments, the network 150 may be an internet, an intranet, or a combination thereof.

It should be noted that the above description of the medical system 100 is merely provided for the purposes of illustration, and not intended to limit the scope of the present disclosure. For persons having ordinary skills in the art, multiple variations and modifications may be made under the teachings of the present disclosure. For example, the assembly and/or function of the medical system 100 may be varied or changed according to specific implementation scenarios. Merely by way of example, some other components may be added into the medical system 100, such as a power supply module that may supply power to one or more components of the medical system 100, and other devices or modules.

FIG. 2A is an exemplary schematic diagram illustrating the processing device 120 according to some embodiments of the present disclosure. As illustrated in FIG. 2A, the terminal(s) 140 may be connected to the processing device 120 via the network 150 as described in FIG. 1. The processing device 120 may then communicate with the terminal(s) 140 via the network 150, for example, receiving data/information/application/user instructions sent from the terminal(s) 140. In some embodiments, the network 150 may include a wide area network (WAN) or a local area network (LAN). The processing device 120 may be connected to and/or communicate with one or more medical devices (e.g., the medical device 110) not shown via the network 150 as described in FIG. 1.

The processing device 120 may include a computing cluster 240, a network 250, a resource manager 260, and a storage device 270. In some embodiments, the terminal(s) 140 may be connected to the resource manager 260 of the computing cluster via the network 150. The terminal(s) 140 may also be connected to the storage device 270 via the network 150 as illustrated by the dotted arrow in FIG. 2A. The components in the processing device 120 may be connected in one or more of various ways. Merely by way of example, one or more computing devices of the computing cluster 240 may be connected to the resource manager 260 and/or the storage device 270 through the network 250. As another example, one or more computing devices of the computing cluster 240 may be connected to the storage device 270 directly as illustrated in FIG. 2A. The storage device 270 may also be connected to the resource manager 260 through the network 250. The network 250 may include any suitable network (e.g., a wide area network (WAN), a local area network (LAN), wired and/or wireless network access points, etc.) that can facilitate the exchange of information and/or data for the processing device 120. In some embodiments, the network 250 may be an internet, an intranet, or a combination thereof.

The computing cluster 240 may include a plurality of computing devices, such as a computing device 240-1, a computing device 240-2, . . . , a computing device 240-N, etc. In some embodiments, the plurality of computing devices may be connected to and/or communicate with each other via a wireless connection (e.g., the network 250), a wired connection, or a combination thereof. For example, the computing device 240-1 may receive data processed by the computing device 240-2 via the network 250. As another example, one of the plurality of computing devices (e.g., the computing device 240-1) may be connected to and/or communicate with other computing devices (e.g., the computing device 240-2) directly.

As used herein, a computing device may be also referred to as a computing node. Each of the plurality of computing devices may include at least one processor and at least one storage device. In some embodiments, a computing device (e.g., the computing device 240-1) may be any suitable computer, such as a laptop, a tablet computer, a desktop, etc. The at least one processor may include a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof. The at least one storage device may store data, instructions, and/or any other information. In some embodiments, the at least one storage device of a computing device may store data obtained from the terminal(s) 140 and/or the resource manager 260. In some embodiments, the storage device may store algorithms and/or instructions that the at least one processor may execute or use to perform exemplary medical applications described in the present disclosure.

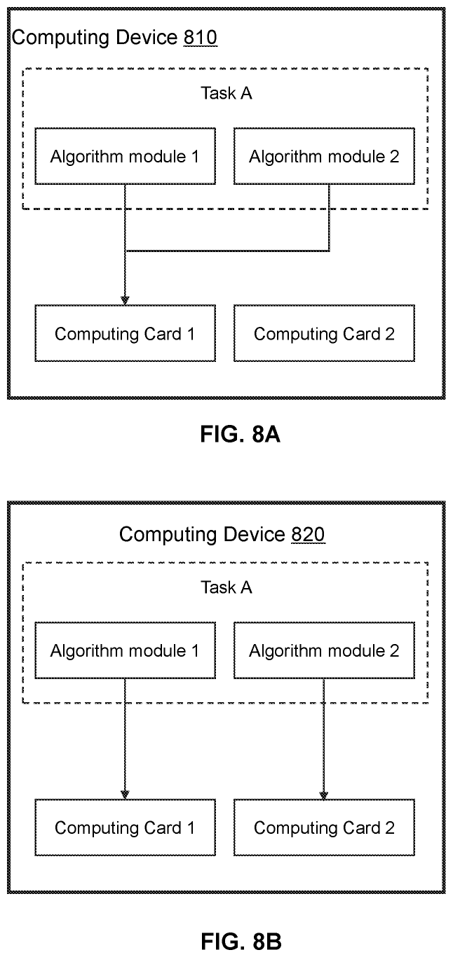

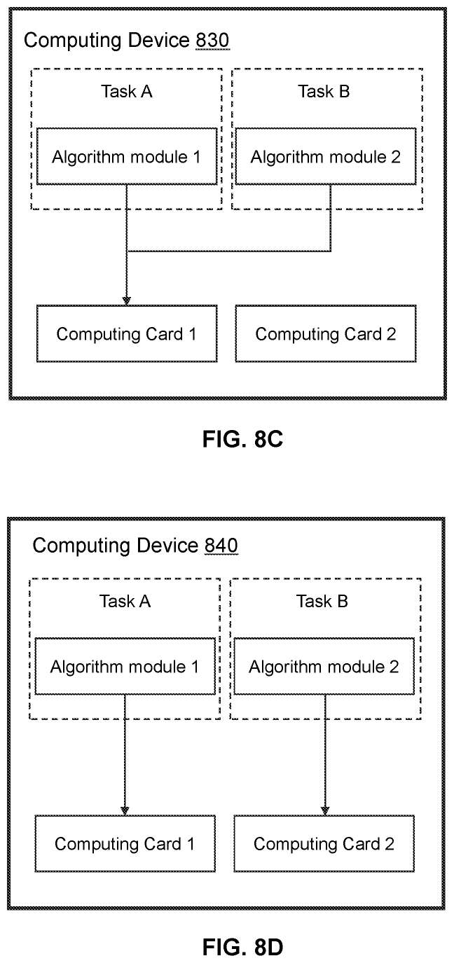

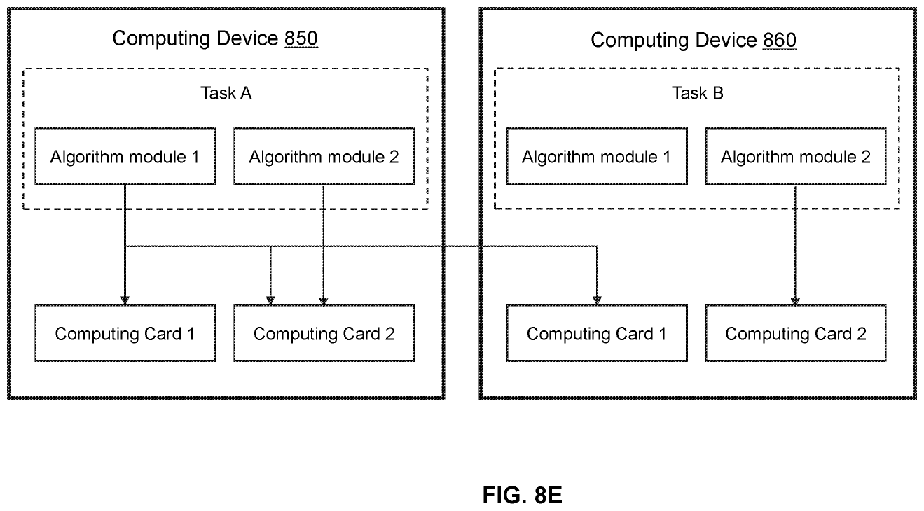

In some embodiments, a computing device may include one or more computing cards. A computing card may include one or more processors, a memory, an onboard storage device, a port or connector, etc. A computing card may be a small portable computing device that can be inserted into, plugged into, or connected to multiple different types of host computing devices (e.g., the terminal(s) 140). More descriptions for the computing device including the computing cards may be found in FIG. 8A-8E.

A computing device (e.g., the computing device 240-1) may execute one or more computing tasks based on computing resources of the computing device. The computing resources of a computing device may relate to a configuration of the computing device, such as the at least one processor and the storage device. Further, the computing resources of a computing device may relate to one or more characteristics (or parameters) associated with the computing device and/or components of the computing device (e.g., the at least one processor). Exemplary characteristics associated with the computing device may include the type of the at least one processor, the type of the at least one storage, the number of the at least one processor, a storage volume of the at least one storage device, a computing capability of the computing device, etc. The type of the at least one processor may include CPU, GPU, etc., as described elsewhere in the present disclosure. The type of the at least one storage may include a mass storage device, a removable storage device, a volatile read-and-write memory, a read-only memory (ROM), etc., as described elsewhere in the present disclosure. The computing capability of the computing device may be defined by the computing speed of the computing device. The higher of the computing speed of the computing device, the higher the computing capability of the computing device may be. The computing speed may be determined based on other characteristics relating to the computing device, for example, the type of the at least one processor, the storage volume of the at least one storage device, etc.

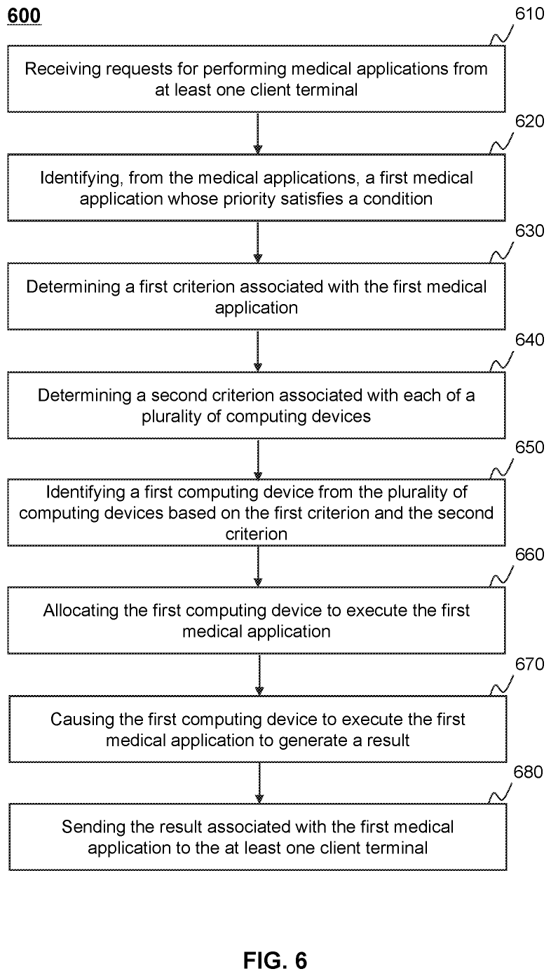

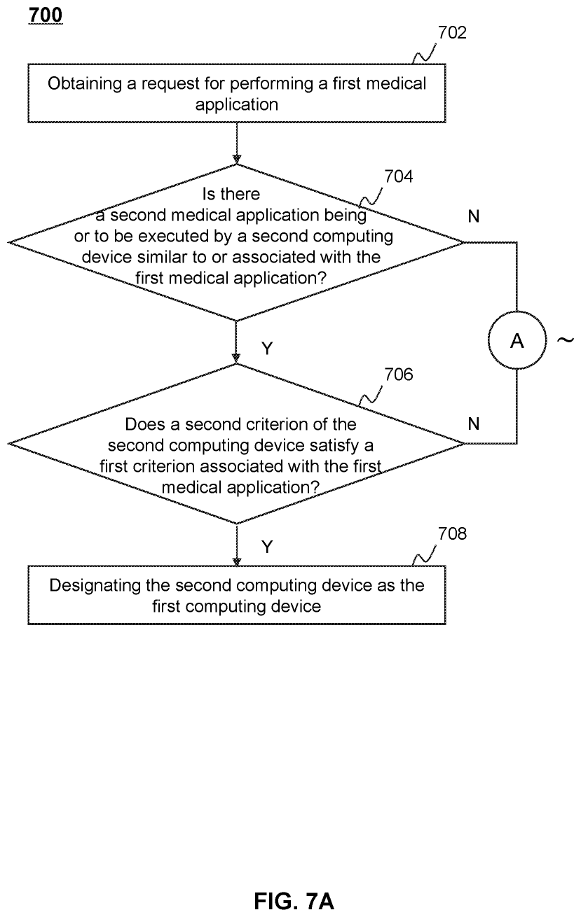

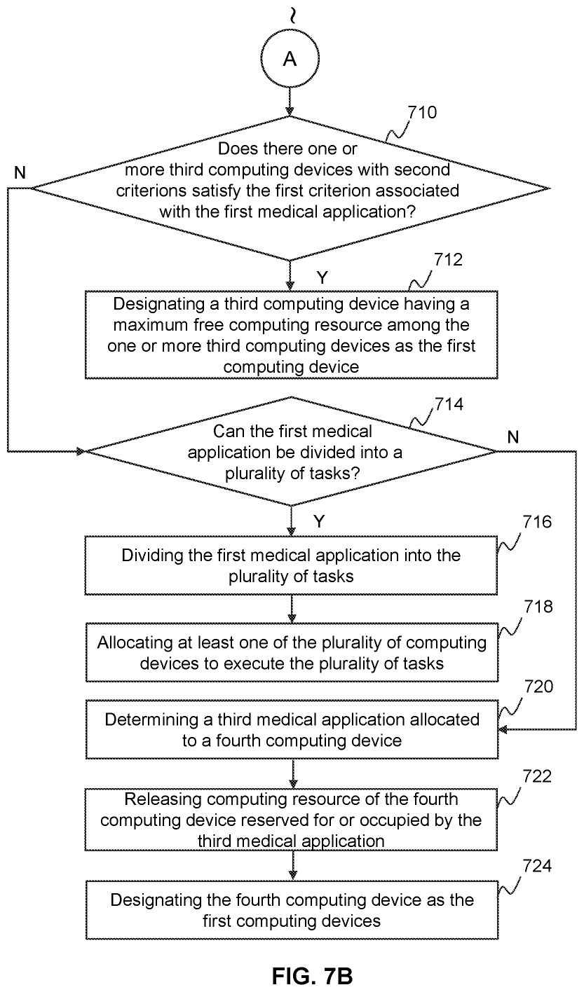

The resource manager 260 may be configured to allocate computing resources of computing cluster 240 for medical applications in response to requests for performing the medical applications. The resource manager 260 may receive the requests for performing the medical applications from the terminal(s) 140. In some embodiments, the resource manager 260 may receive one or more requests at the same time, thus it is necessary for the resource manager 260 to allocate the plurality of computing devices to execute the medical applications according to a load balancing algorithm or a strategy. Exemplary load balancing algorithms may include a round robin algorithm, a weighted round robin algorithm, an auto back up algorithm, a minimum connection number algorithm, a random algorithm, a weighted random algorithm, etc. In some embodiments, the resource manager 260 may allocate a computing device to execute a medical application based on the priority of the medical application. More detailed descriptions for allocate the medical applications based on priorities may be found elsewhere in the present disclosure, e.g., FIG. 6, FIG. 7A, and FIG. 7B, and descriptions thereof.

The storage device 270 may store data, instructions, and/or any other information. In some embodiments, the storage device 270 may store data obtained from the terminal(s) 140 and/or the resource manager 260. For example, the storage device 270 may store configuration information of each of the plurality of computing devices. In some embodiments, the storage device 270 may store data and/or instructions that the resource manager 260 may execute or use to perform exemplary methods/systems described in the present disclosure.

FIG. 2B is another exemplary schematic diagram illustrating the processing device 120 according to some embodiments of the present disclosure. As shown in FIG. 2B, the processing device 120 may include a computing cluster 230, a network 250, a resource manager 260, a storage device 270, and a network load balancer 280. In some embodiments, the terminal(s) 140 may be connected to the network load balancer 280 of the computing cluster via the network 150. The terminal(s) 140 may also be connected to the storage device 270 as illustrated by the dotted arrow in FIG. 2B. The components, e.g., virtual machines (VM), in the computing cluster 230 may be connected in one or more of various ways. Merely by way of example, each of the computing cluster 230 may be connected to the resource manager 260 through the network 250. Each of the computing cluster 230 may also be connected to the storage device 270 through the network 250. As another example, each of the computing cluster 230 may be connected to the storage device 270 directly as illustrated in FIG. 2B. The storage device 270 may also be connected to the resource manager 260 through the network 250. The network load balancer 280 may be connected to the resource manager 260 through wired of wireless communication.

In some embodiments, one or more components of the processing device 120 as shown in FIG. 2B may be same as or similar to the processing device 120 as shown in FIG. 2A. For example, the computing cluster 230, the network 250, and/or the storage device 270 may be same as or similar to computing cluster 240, the network 250, and/or the storage device 270 respectively as described in FIG. 2A. As a further example, each of the plurality of computing devices in the computing cluster 230 may include at least one processor and at least one storage device. In some embodiments, one or more components of the processing device 120 as shown in FIG. 2B may be different from the processing device 120 as shown in FIG. 2A. For example, the computing cluster 230 may include a plurality of virtual machines (e.g., a VM 0, a VM 1, a VM 2, . . . , a VM N, etc.). The computing cluster 240 may include a plurality of entity machines. As another example, the processing device 120 as shown in FIG. 2B may further include the network load balancer 280.

In some embodiments, a virtual machine (VM) may be an operating system (OS) or application environment that is installed on software, which imitates a physical computer (e.g., one of the plurality of computing devices in the computing cluster 240). In some embodiments, at least one of the plurality of virtual machines may be integrated into a client terminal (e.g., the terminal(s) 140), a medical device (e.g., the medical device 110), or an entity machine (e.g., a laptop). For example, the VM 0 may be integrated into the terminal(s) 140. As another example, the VM 1, the VM 2, . . . , the VM N may be integrated into the medical device 110. A user (e.g., a doctor, a researcher, etc.) may have the same experience on a virtual machine as they would have on an entity machine or a physical computer. In this case, the number or count of the computing devices within the computing cluster may increase, which may improve the efficiency of the computing cluster 230.

The network load balancer 280 may be configured to allocate the requests for performing the medical applications to the resource manager 260. In some embodiments, the network load balancer 280 may be integrated with the resource manager. The network load balancer 280 may include a computing device as described elsewhere in the present disclosure.

It should be noted that the above description of a computing cluster is merely provided for the purposes of illustration, and not intended to limit the scope of the present disclosure. For persons having ordinary skills in the art, multiple variations and modifications may be made under the teachings of the present disclosure. For instance, the assembly and/or function of the computing cluster may be varied or changed according to specific implementation scenarios. Merely by way of example, at least two components of the computing cluster may be integrated into a console. As another example, some other components/modules may be added into the computing cluster, such as a network switch, a workflow network server, etc. Such variations and modifications do not depart from the scope of the present disclosure.

FIG. 3 is a schematic diagram illustrating an exemplary computing device 300 on which the medical system 100 can be implemented according to some embodiments of the present disclosure.

The computing device 300 may be a general purpose computer or a special purpose computer. Both may be used to implement a medical system of the present disclosure. The computing device 300 may be used to implement any component of the service as described herein. For example, the processing device 120 of the medical system 100 may be implemented on the computing device 300, via its hardware, software program, firmware, or a combination thereof. Although only one such computer is shown for convenience, the computer functions related to the medical system 100 as described herein may be implemented in a distributed manner on a number of similar devices/platforms to distribute the computing load.

The computing device 300, for example, may include COMM ports 350 connected to and from a network (e.g., the network 150) connected thereto to facilitate data communications. In some embodiments, the COMM ports 350 may transmit to and receive information or data from any one of acquisition module 510, schedule determination module 520, criterion determination module 530, and allocation module 540. In some embodiments, the COMM ports 350 may include a wired port (e.g., a Universal Serial Bus (USB) port, a High Definition Multimedia Interface (HDMI) port, etc.) or a wireless port (a Bluetooth port, an infrared interface, a WiFi port, etc.).

The computing device 300 may also include a processing unit 320 (e.g., a central processing unit (CPU), a graphics processing unit (GPU), etc.), in the form of one or more processors, for executing computing instructions. Computing instructions may include routines, programs, objects, components, data structures, procedures, modules, and functions, which perform particular functions described herein. For example, the processing unit 320 may process the data or information received from the acquisition module 510, the schedule determination module 520, the criterion determination module 530, and the allocation module 540, or any other component of the medical system 100. In some embodiments, the processing unit 320 may include a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof. For example, the processing unit 320 may include a microcontroller to process data (e.g., raw PET data) from the medical device 110 (e.g., a PET scanner) for image reconstruction.

The computing device 300 may also include an internal communication bus 310, program storage and data storage of different forms, for example, a disk 370, and a read only memory (ROM) 330, or a random access memory (RAM) 340, for various data files to be processed and/or transmitted by the computer. The disk 370 may include, for example, a floppy disk, an optical disk, a zip disk, etc. The ROM 330 may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. The RAM 340 may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. In some embodiments, the computing device 300 may also include program instructions stored in the ROM 330, the RAM 340, and/or another type of non-transitory storage medium to be executed by the processing unit 320. The methods and/or processes of the present disclosure may be implemented as the program instructions. The computing device 300 may also include an I/O 360, supporting input/output between the computer and other components therein. The computing device 300 may also receive programming and data via network communications.

Merely for illustration, only one processing unit and/or processor is described in the computing device 300. However, it should be noted that the computing device 300 in the present disclosure may also include multiple processing units and/or processors, thus operations and/or method steps that are performed by one processing unit and/or processor as described in the present disclosure may also be jointly or separately performed by the multiple processing units and/or processors. For example, the processing unit and/or processor of the computing device 300 executes both operation A and operation B. As in another example, operation A and operation B may also be performed by two different processing units and/or processors jointly or separately in the computing device 300 (e.g., the first processor executes operation A, and the second processor executes operation B; or the first and second processors jointly execute operations A and B).

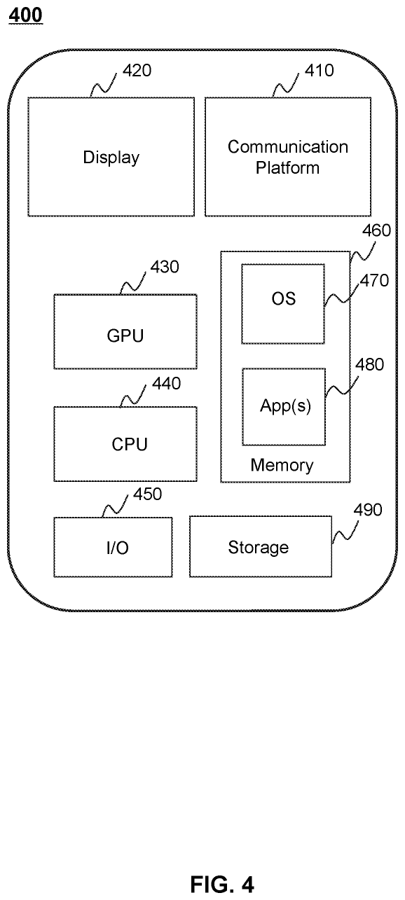

FIG. 4 is a schematic diagram illustrating exemplary hardware and/or software components of an exemplary mobile device 400 on which the terminal(s) 140 may be implemented according to some embodiments of the present disclosure. As illustrated in FIG. 4, the mobile device 400 may include a communication platform 410, a display 420, a graphics processing unit (GPU) 430, a central processing unit (CPU) 440, an I/O 450, a memory 460, and a storage 490. In some embodiments, any other suitable component, including but not limited to a system bus or a controller (not shown), may also be included in the mobile device 400. In some embodiments, a mobile operating system 470 (e.g., iOS™, Android™, Windows Phone™) and one or more applications 480 may be loaded into the memory 460 from the storage 490 in order to be executed by the CPU 440 and/or the GPU 430. The applications 480 may include a browser or any other suitable mobile apps for receiving and rendering information relating to image processing or other information from the processing device 120. User interactions with the information stream may be achieved via the I/O 450 and provided to the processing device 120 and/or other components of the medical system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

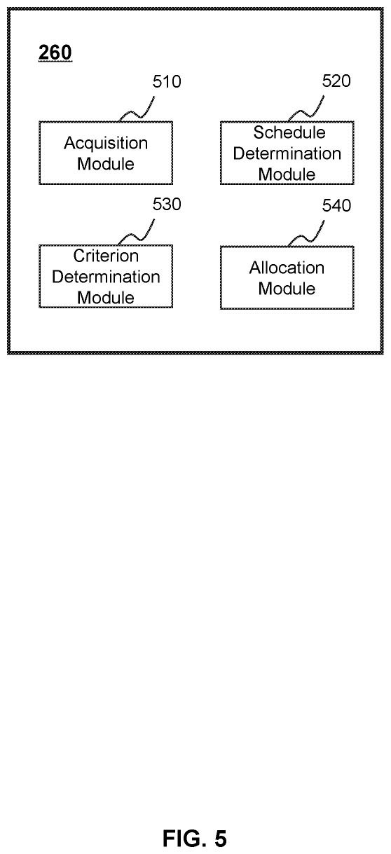

FIG. 5 is a block diagram illustrating an exemplary resource manager 260 according to some embodiments of the present disclosure. In some embodiments, the resource manager 260 may be implemented on a computing device as illustrated in FIG. 2A and/or FIG. 2B. As illustrated in FIG. 5, the resource manager 260 may include an acquisition module 510, a schedule determination module 520, a criterion determination module 530, and an allocation module 540. In some embodiments, the modules may be connected with each other via a wired connection (e.g., a metal cable, an optical cable, a hybrid cable, or the like, or any combination thereof) or a wireless connection (e.g., a Local Area Network (LAN), a Wide Area Network (WAN), a Bluetooth, a ZigBee, a Near Field Communication (NFC), or the like, or a combination thereof).

The acquisition module 510 may be configured to acquire or receive requests for performing medical applications from at least one client terminal. A medical application may include an image reconstruction application, an image post-processing application, a volume rendering application, a virtual reality application, an artificial intelligence application, or the like, or any combination thereof. Each of the medical applications may have a priority. The priority of each of the medical applications may be set by a user (e.g., an operator or a doctor) or according to a default setting of the medical system 100 as described elsewhere in the present disclosure (e.g., FIG. 6 and the descriptions thereof). In some embodiments, the request for performing a medical application may include a computing protocol corresponding to the medical application. The computing protocol within the request for performing the medical application may be used by one or more computing devices to execute the medical application. In some embodiments, the computing protocol corresponding to the medical application may include raw data associated with the medical application, algorithms and/or models for executing the medical application, the priority of the medical application, or the like, or a combination thereof. The acquisition module 510 may transmit the requests to other components of the resource manager 260 for further processing. For example, the acquisition module 510 may transmit the request to the schedule determination module 520 to determine a medical application having a highest priority.

The schedule determination module 520 may be configured to identify a first medical application whose priority satisfies a condition from the medical applications. In some embodiments, the resource manager 260 (e.g., the schedule determination module 520) may rank the medical applications by priority. The priority of a medical application may satisfy the condition if the schedule determination module 520 determines that the priority of the medical application is ranked in the top few (e.g., the top one, the top two, the top three, etc.). For example, the resource manager 260 may determine one or more candidate medical applications with the highest priority from the medical applications. As another example, the resource manager 260 may determine two or more candidate medical applications whose priorities are in the top two or more. The schedule determination module 520 may determine the first medical application from the candidate medical applications based on one or more characteristics of the candidate medical applications as described elsewhere in the present disclosure, such as queue time, an estimated computing resource (e.g., an estimated storage volume the medical application needs to occupy), etc. The schedule determination module 520 may transmit the requests to other components of the resource manager for 260 further processing. For example, the schedule determination module 520 may transmit the identified first medical application to the criterion determination module 530 to determine estimated computing resources the first medical application demands.

The criterion determination module 530 may be configured to determine a first criterion associated with the first medical application. The first criterion may indicate estimated computing resources that the first medical application demands. The estimated computing resources that the first medical application demands may be determined based on one or more characteristics of the first medical application (also referred to as task properties). For example, the estimated computing resources that the first medical application demands may include an estimated storage volume the first medical application occupies, a type of a computing device executing the first medical application, a computing capability of the computing device, an estimated execution duration the first medical application requires, or the like, or any combination thereof.

The criterion determination module 530 may also be configured to determine a second criterion associated with each of the plurality of computing devices. The second criterion associated with a computing device may indicate a characteristic of the computing device. The characteristic of a computing device may indicate the free computing resources of the computing device owns. The characteristic of a computing device may include a free storage volume of a computing device, a type of a processing unit (e.g., CPU, GPU, FPGA, etc.) within the computing device, a time period the computing resources of the computing device can be occupied, a computing capability of the computing device, or the like, or any combination thereof. The criterion determination module 530 may transmit the requests to other components of the resource manager for 260 further processing. For example, the criterion determination module 530 may transmit the first criterion and the second criterion to the allocation module 540 to determine a computing device for executing the first medical application.

The allocation module 540 may be configured to identify a first computing device from the plurality of computing devices based on the first criterion and the second criterion. In some embodiments, the allocation module 540 may identify the first computing device from the plurality of computing devices if the first criterion satisfies the second criterion. As used herein, the first criterion satisfying with the second criterion may refer to that one or more estimated computing resource associated with the first medical application is consistent with or satisfy one or more free computing resource of the first computing device. For example, an estimated storage volume the first medical application occupies may be equal to or less than free storage volume of the first computing device. As another example, a type of a computing device executing the first medical application may be similar to or same as a type of a processing unit (e.g., CPU, GPU, FPGA, etc.) within the first computing device.

In some embodiments, the resource manager 260 may include a recording module (not shown in the figure). The recording module may be configured to reserve one portion of computing resources of an allocated computing device for the first medical application. The one portion of the computing resources of the allocated computing device may be greater than or equal to the estimated computing resources that the first medical application demands, which ensures that the allocated computing device may have sufficient free computing resources to execute the first medical application. The recording module may record the one portion of the computing resources of the allocated computing device for the first medical application, and may release the one portion of the computing resources of the allocated computing device when the allocated computing device finishes executing the first medical application.

It should be noted that the above description of the resource manager 260 is merely provided for the purposes of illustration, and not intended to limit the scope of the present disclosure. For persons having ordinary skills in the art, multiple variations and modifications may be made under the teachings of the present disclosure. For instance, the assembly and/or function of the resource manager 260 may be varied or changed according to specific implementation scenarios. Merely by way of example, at least two modules of the acquisition module 510, the schedule determination module 520, the criterion determination module 530, and the allocation module 540 may be integrated into a console. As another example, some other components/modules may be added into the resource manager 260. Such variations and modifications do not depart from the scope of the present disclosure.

FIG. 6 is a flowchart illustrating an exemplary process of allocating computing resources for medical applications according to some embodiments of the present disclosure. In some embodiments, one or more operations of the process 600 illustrated in FIG. 6 for allocating computing resources to execute the medical applications may be implemented in the medical system 100 illustrated in FIG. 1. For example, the process 600 illustrated in FIG. 6 may be stored in the storage device 130 in the form of instructions, and invoked and/or executed by the processing device 120 (e.g., the resource manager 260 (e.g., the processing unit 320 of the computing device 300 as illustrated in FIG. 3, the GPU 430 or CPU 440 of the mobile device 400 as illustrated in FIG. 4)).

In 610, the resource manager 260 (e.g., the acquisition module 510) may receive requests for performing medical applications from the at least one client terminal via a user interface. The medical applications may include an image reconstruction application, an image post-processing application, a volume rendering application, a virtual reality application, an artificial intelligence application, etc., as described elsewhere in the present disclosure (e.g., FIG. 1 and the descriptions thereof). Each of the medical applications may have a priority. The priority of each of the medical applications may be set by a user (e.g., an operator or a doctor) or according to a default setting of the medical system 100. In some embodiments, the user (e.g., an operator or a doctor) may set the priority of a medical application manually via the at least one client terminal (e.g., the terminal(s) 140). In some embodiments, the priority of a medical application may be determined based on one or more evaluation parameters relating to a characteristic of the medical application by the processing device 120. The characteristic of a medical application may relate to raw data to be processed, algorithms and/or models for processing the medical application, the type of the medical application, etc. For example, the characteristic relating to raw data associated with a medical application may include data size of the raw data, the type of the raw data (e.g., images, projection data, etc.), etc. The characteristic relating to algorithms and/or models for processing a medical application may include the number or count of algorithms and/or models to be involved, the type of an algorithm to be used, etc. Exemplary evaluation parameters may include a desired response time for the computing result of the medical application, an estimated storage volume the medical application occupies, the desired computing capability of a computing device the medical application needs, an estimated executing duration of the medical application, a tolerable queue time of the medical application, etc. For example, a medical application may have a relatively higher priority if the medical application desires a shorter response time for the computing result. As another example, the longer the estimated computing duration of a medical application, the higher the priority of the medical application may be. As a further example, with reference to an image reconstruction application or a volume rendering application, such medical applications may have a relatively higher priority because a user (e.g., a doctor, a researcher, etc.) may need to see the real-time rendering process or the reconstructed image immediately for further analysis, diagnosis, treatment, treatment planning, etc. An image post-processing application may have a relatively lower priority because a user may afford to wait to see the real-time post-processing process or the computing result immediately. When there is a competing needs for computing resources, such medical applications with lower priorities (e.g., an image post-processing application) may be processed in the background or even paused, in order to allow a medical application with higher priority to be executed timely.

In some embodiments, each of the evaluation parameters for a medical application may be assigned with a weight value. The weight value corresponding to an evaluation parameter may indicate the contribution of the evaluation parameter to the priority of the medical application. The priority of the medical application may be determined based on the weight values and the evaluation parameters. For example, the priority of the medical application may relate to a weighted sum of the evaluation parameters based on the weight value corresponding to each of the evaluation parameters; the greater the weighted sum of the evaluation parameters for a medical application is, the higher the priority of the medical application may be. The weight value corresponding to each of the evaluation parameters may be preset by a user or according to a default setting of the medical system 100. For example, the weight value may be a constant lower than 1.

In some embodiments, the request for performing a medical application may include a computing protocol corresponding to the medical application. The computing protocol within the request for performing the medical application may be used by one or more computing devices to execute the medical application. In some embodiments, the computing protocol corresponding to the medical application may include raw data to be processed, algorithms and/or models for executing the medical application, the priority of the medical application, or the like, or a combination thereof. The raw data may include image data generated by the medical device 110 (e.g., a PET scanner, a CT scanner, a DR scanner, an MR scanner, etc.) of the medical system 100 via scanning a subject, an image (e.g., a 2D image, an 3D image, etc.) reconstructed based on the image data, etc. In some embodiments, the computing protocol may include identification information associated with the medical application. The identification information associated with the medical application may be configured to retrieve, identify, and/or obtain raw data to be processed and/or an algorithm (or model) for processing the raw data associated with the medical application from the storage device 130, the storage device 270, the storage 490, or other external storages. In this case, the image data to be processed may be stored in the storage device 130, the storage device 270, the storage 490, or other external storages in advance.

In 620, the resource manager 260 (e.g., the schedule determination module 520) may identify a first medical application whose priority satisfies a condition from the medical applications. In some embodiments, the resource manager 260 (e.g., the schedule determination module 520) may rank the medical applications by priority. The priority of a medical application may satisfy the condition if the schedule determination module 520 determines that the priority of the medical application is ranked in the top few (e.g., the top one, the top two, the top three, etc.). For example, the resource manager 260 may determine one or more candidate medical applications with the highest priority from the medical applications. As another example, the resource manager 260 may determine two or more candidate medical applications whose priorities are in the top two or more.

In some embodiments, there may be two or more candidate medical applications having a same or similar priority (e.g., medical applications having the highest priority or whose priorities is in the top two). The resource manager 260 may determine the first medical application from the candidate medical applications based on one or more evaluation parameters of the candidate medical applications as described elsewhere in the present disclosure, such as queue time, an estimated storage volume the medical application needs to occupy, etc. For example, the resource manager 260 may determine one of the candidate medicals as the first medical application whose queue time is longer than that of other candidate medical applications. The queue times of the candidate medical applications may be determined by the resource manager 260 respectively. As another example, the resource manager 260 may determine one of the candidate medical application as the first medical application whose occupied estimated storage volume is higher than that of other candidate medical applications. As still another example, the resource manager 260 may determine one of the candidate medical application as the first medical application whose estimated execution duration is shorter than that of other candidate medical applications.

In 630, the resource manager 260 (e.g., the criterion determination module 530) may determine a first criterion associated with the first medical application. The first criterion may indicate or relate to an estimated computing resource that the first medical application demands. The estimated computing resource that the first medical application demands may relate to one or more characteristics of the first medical application. For example, the estimated computing resource that the first medical application demands may include an estimated storage volume the first medical application occupies, a type of a computing device executing the first medical application, a computing capability of the computing device the first medical application demands, an estimated execution duration the first medical application requires, or the like, or any combination thereof. As a further example, the first medical application may be a volume rendering application, and the estimated computing resource that the volume rendering application demands may include a computing device with at least one GPU and at least one CPU, a storage volume of 1 gigabytes (GB), and a computing capability of the computing device executing 3 million instructions per second.

In some embodiments, the estimated computing resource that the first medical application demands may be determined based on a characteristic associated with the first medical application and/or may be set by a user via the at least one client terminal. The characteristic associated with the first medical application may relate to raw data associated with the first medical application, algorithms and/or models for executing the medical application, the type of the first medical application, etc. For example, the greater the data size of the raw data associated with the first medical application is, the larger the estimated storage volume the first medical application occupies may be. As another example, an artificial intelligence application may need a computing device with a higher computing capability than that of a computing device an image reconstruction application needs.

In 640, the resource manager 260 (e.g., the criterion determination module 530) may determine a second criterion associated with each of a plurality of computing devices. The second criterion associated with a computing device may relate to one or more characteristics of the computing device. The characteristics of the computing device may relate to a configuration of the computing device. The characteristic of a computing device may indicate the free computing resources of the computing device owns at a specific time. The characteristic of a computing device may include a free storage volume of the computing device, a type of a free processing unit (e.g., CPU, GPU, FPGA, etc.) of the computing device, a time period the free computing resources of the computing device can be occupied, a computing capability of the computing device, or the like, or any combination thereof. In some embodiments, the second criterion associated with a computing device may be determined by the computing device. For example, the computing device may determine free computing resources of the computing device and report the free computing resources of the computing device to the resource manager 260 (e.g., the criterion determination module 530).

In some embodiments, the second criterion associated with a computing device may be determined by the resource manager 260 (e.g., the criterion determination module 530). For example, the criterion determination module 530 may query the computing device for a computing resource occupied by or reserved for other medical applications and total computing resource. The criterion determination module 530 may determine the free computing resource of the computing device based on the occupied computing resource and the total computing resource. As another example, the criterion determination module 530 may receive the free computing resource of the computing device reported by the computing device. The criterion determination module 530 may further determine the second criterion including the free computing resource of the computing device.

In 650, the resource manager 260 (e.g., the allocation module 540) may identify a first computing device from the plurality of computing devices based on the first criterion and the second criterion. In some embodiments, the resource manager 260 may identify the first computing device from the plurality of computing devices if the first criterion satisfies the second criterion. As used herein, the first criterion satisfying with the second criterion may refer to that the estimated computing resource associated with the first medical application is consistent with or matches with the free computing resource of the first computing device. For example, the estimated storage volume the first medical application occupies may be equal to or less than the free storage volume of the first computing device. As another example, the type of a computing device executing the first medical application may be similar to or same as a type of a processing unit (e.g., CPU, GPU, FPGA, etc.) within the first computing device. As still another example, the computing capability of the first medical application requiring may be equal to or less than the computing capability of the first computing device. In some embodiments, the resource manager 260 may determine multiple candidate computing devices from the plurality of the computing devices. The second criterion associated with each of the candidate computing devices may satisfy the first criterion associated with the first medical application. The resource manager 260 may determine one of the candidate computing devices having a maximum free computing resource as the first computing device.

In some embodiments, the resource manager 260 may identify the first computing device from the plurality of computing devices based on a matching degree between the first criterion and the second criterion. As used herein, the matching degree between the first criterion and the second criterion may be used to indicate conformity between the free computing resource of the first computing device and the estimated computing resource the first medical application demands. The higher the matching degree between the first criterion and the second criterion is, the more appropriately the first computing device may be allocated to execute the first medical application. The matching degree between the first criterion and the second criterion may be determined based on a similarity between the free computing resource of the first computing device and the estimated computing resource the first medical application demands. The similarity between the free computing resource of the first computing device and the estimated computing resource the first medical application demands may be assessed based on a distance between the free computing resource of the first computing device and the estimated computing resource the first medical application demands. Exemplary distances may include a Euclidean distance, a Manhattan distance, a Minkowski distance, or the like, or a combination thereof.

In some embodiments, the resource manager 260 may determine the first computing device from the plurality of computing devices by determining whether the first medical application is similar to or associated with a second medical application being executed by a second computing device. If the resource manager 260 determines that the first medical application is similar to or associated with a second medical application, the resource manager 260 may determine whether the second criterion of the second computing device satisfies the first criterion of the first medical application. If the resource manager 260 determines that the second criterion of the second computing device satisfies the first criterion, the resource manager 260 may designate the second computing device as the first computing device. As used herein, a similarity or association between two medical applications (e.g., the first medical application and the second medical application) may be also referred to as a task affinity between the two medical applications.

In some embodiments, if the resource manager 260 determines that the second criterion of the each of the plurality of computing devices does not satisfy the first criterion associated with the first medical application, the resource manager 260 may search for a computing device already allocated to a medical application (or referred to as an allocated medical application) whose priority is lower than the first medical application. The resource manager 260 may release the computing resource of the allocated medical application occupies and designate the computing resource of the allocated medical application occupies to the first medical application.

In some embodiments, if the resource manager 260 determines that the second criterion of the each of the plurality of computing devices does not satisfy the first criterion associated with the first medical application, the resource manager 260 may divide the first medical application into a plurality of tasks and determine the first computing device based on the plurality of tasks. Detailed descriptions of identifying the first computing device from the plurality of computing devices may be found elsewhere in the present disclosure, e.g., FIGS. 7A-7B and descriptions thereof.

In 660, the resource manager 260 (e.g., the allocation module 540) may allocate the first computing device to execute the first medical application. In some embodiments, the resource manager 260 may send the request for performing the first medical application to the first computing device.

In some embodiments, the resource manager 260 may reserve one portion of the computing resource of the first computing device for the first medical application. The one portion of the computing resource of the first computing device may be greater than or equal to the estimated computing resource that the first medical application demands, which ensures that the first computing device may have sufficient free computing resource to execute the first medical application during the estimated execution duration the first medical application requires. The resource manager 260 may record the one portion of the computing resource of the first computing device allocated to the first medical application. And the resource manager 260 may release the one portion of the computing resource of the first computing device when the first computing device finishes executing the first medical application.

In some embodiments, after allocating the first medical application to the first computing device, the resource manager 260 may identify the free computing resource of the first computing device based on the estimated computing resource that the first medical application demands and/or the one portion of the computing resources of the first computing device reserved for executing the first medical application. The identified free computing resource of the first computing device may include computing resource except the estimated computing resource that the first medical application demands and/or the one portion of the computing resource of the first computing device reserved for executing the first medical application. The resource manager 260 may then record the identified free computing resource of the first computing device. In the same way, the resource manager 260 may update the second criterion associated with each of the plurality of computing device based on the identified free computing resource of each of the plurality of computing devices.

In some embodiments, the resource manager 260 may provide a notification, via a user interface to a client terminal, that a computing device has been allocated to execute the first medical application.

In 670, the first computing device may execute the first medical application to generate a result. The first computing device may execute the first medical application to generate the result based on the request for performing the first medical application. In some embodiments, the request for performing the first medical application may include a computing protocol associated with the first medical application. The computing protocol associated with the first medical application may include the raw data to be processed and/or algorithms for processing the raw data. The first computing device may execute the first medical application directly based on the raw data and/or the algorithms for processing the raw data after receiving the request for performing the first medical application. In some embodiments, the first computing device may obtain the raw data and/or the algorithms for processing the raw data from a storage device (e.g., the storage device 270) based on the computing protocol associated with the first medical application.

The result associated with the first medical application may include one or more images (e.g., 2D images, 3D images, etc.), one or more data figures, one or more words, one or more digits, one or more models for performing the first medical application, one or more data tables, etc. For example, the first medical application may be an image reconstruction application. The result associated with the image reconstruction application may be one or more reconstructed images. As another example, the first medical application may relate to an image post-processing, such as image denoising based on a deep learning technique. The result associated with the first medical application may include a neural network model for denoising and/or images denoised based on the neural network model.

In some embodiments, after the first computing device finishes executing the first medical application to generate the result, the estimated computing resources that the first medical application demands and/or the one portion of the computing resources of the first computing device reserved for executing the first medical application may be released and become free. The resource manager 260 may identify free computing resource of the first computing device based on the estimated computing resource that the first medical application demands and/or the one portion of the computing resource of the first computing device reserved for executing the first medical application. The identified free computing resource of the first computing device may be increased by adding the estimated computing resource that the first medical application demands and/or the one portion of the computing resource of the first computing device reserved for executing the first medical application into the identified free computing resource. The resource manager 260 may then record the identified free computing resource of the first computing device. In the same way, the resource manager 260 may update the second criterion associated with each of the plurality of computing devices based on identified free computing resource of each of the plurality of computing devices.

In 680, the first computing device may send the result associated with the first medical application to the at least one client terminal. In some embodiments, the first computing device may send the result (e.g., one or more reconstructed images) associated with the first medical application (e.g., an image reconstruction application) to the at least one client terminal via the network 150 after finishing executing the first medical application. In some embodiments, the at least one client terminal may display the result (e.g., one or more images, one or more data figures, etc.) associated with the first medical application on a user graphic interface (GUI) of the at least one client terminal. In some embodiments, the result associated with the first medical application may be processed by the first computing device or other computing devices as a second medical application. For example, the first medical application may be an image reconstruction application. The result of the first medical application may include multiple 2D images. The 2D images may be further processed by the first computing device or other computing devices to execute a 3D rendering application.

It should be noted that the above description of the process of allocating computing resources for medical applications in response to requests for performing the medical applications is merely provided for the purposes of illustration, and not intended to limit the scope of the present disclosure. For persons having ordinary skills in the art, multiple variations and modifications may be made under the teachings of the present disclosure. For example, process 600 may further include an operation in which free computing resources of each of the plurality of computing devices may be updated at time intervals (e.g., 0.05s). Such variations and modifications do not depart from the scope of the present disclosure.

FIG. 7A and FIG. 7B are flowcharts illustrating another exemplary process of allocating computing resources for medical applications in response to requests for performing the medical applications according to some embodiments of the present disclosure. In some embodiments, one or more operations of the process 700 illustrated in FIG. 7A and FIG. 7B for allocating computing resources to execute the medical applications may be implemented in the medical system 100 illustrated in FIG. 1. For example, the process 700 illustrated in FIG. 7A and FIG. 7B may be stored in the storage device 130 in the form of instructions, and invoked and/or executed by the processing device 120 (e.g., the resource manager 260 (e.g., the processing unit 320 of the computing device 300 as illustrated in FIG. 3, the GPU 430 or CPU 440 of the mobile device 400 as illustrated in FIG. 4))).

In 702, the resource manager 260 (e.g., the allocation module 540) may obtain a request for performing a first medical application. In some embodiments, the first medical application may be one of a plurality of medical applications whose priority satisfies a condition. The first medical application may be identified by the resource manager 260 (e.g., the schedule determination module 520) with reference to operation 620 as illustrated in FIG. 6. The request for performing the first medical application may be transmitted by a client terminal (e.g., the terminal(s) 140) to the allocation module 540 via wired or wireless communication.

In 704, the resource manager 260 (e.g., the allocation module 540) may determine whether there is a second medical application being or to be executed by a second computing device similar to or associated with the first medical application. In response to the determination that the there is a second medical application executed by a second computing device similar to or associated with the first medical application, process 700 may proceed to 706; otherwise, process 700 may proceed to node A and perform at least some of operations starting from node A illustrated in FIG. 7B.

In some embodiments, whether a second medical application is similar to or associated with the first application may be determined based on a similarity between characteristics of the first medical application and the second application as described elsewhere in the present disclosure. The characteristic of a medical application may relate to raw data of the medical application, algorithms and/or models for executing the medical application, the type of the medical application, etc. For example, whether the second medical application is similar to or associated with the first application may be determined based on a similarity between the characteristics of the first medical application and the second medical application, for example, the similarity between the types of the first medical application and the second medical application, the similarity between the algorithms for executing the first medical application and the second medical application, etc.

In some embodiments, whether the second medical application is associated with the first application may be determined based on whether an association relationship exists between the second medical application and the first medical application. In some embodiments, the resource manager 260 may determine that the association relationship exists between the second medical application and the first medical application if the raw data of the first medical application is the same as or can be extracted from the raw data of the second medical application. In some embodiments, whether the association relationship exists between the second medical application and the first medical application may be determined based on a result and/or intermediate data generated in the computing process of the second medical application. For example, if the raw data of the first medical application is the result and/or the intermediate data (e.g., models, images, etc.) generated by executing the second medical application, the second medical application may be determined to have the association relationship with the first medical application.

In 706, the resource manager 260 (e.g., the allocation module 540) may determine whether a second criterion of the second computing device satisfies a first criterion associated with the first medical application. In response to the determination that the second criterion associated with the second computing device satisfies the first criterion associated with the first medical application, process 700 may proceed to 708; otherwise, process 700 may proceed to node A and perform at least some of operations starting from node A illustrated in FIG. 7B.

If the second medical application executed by the second computing device is similar to or associated with the first medical application, the resource manager 260 may further determine whether the second criterion associated with the second computing device satisfies the first criterion associated with the first medical application. The first criterion associated with the first medical application may relate to estimated resources the first medical application demands, such as an estimated storage volume the first medical application occupies, a type of a computing device executing the first medical application, a computing capability of the computing device the first medical application demands, an estimated execution duration the first medical application requires, etc. The first criterion associated with the first medical application may be determined as described in connection with operation 630. The second criterion associated with the second computing device may relate to the free computing resource the second computing device owns, such as a free storage volume of the second computing device, a type of a free processing unit (e.g., CPU, GPU, FPGA, etc.) within the second computing device, a time period the computing resources of the second computing device can be occupied, a computing capability of the second computing device, etc. The second criterion associated with the second computing device may be determined by the resource manager 260 as described in connection with operation 640 as described in FIG. 6. In some embodiments, if the free computing resource of the second computing device is consistent with (e.g., greater than or equal to) the estimated computing resource that the first medical application demands, the second criterion associated with the second computing device may be determined to satisfy the first criterion associated with the first medical application. For example, if the free storage volume of the second computing device, the time period the free computing resource of the second computing device can be occupied, and/or the computing capability of the second computing device the second criterion are greater than or equal to the estimated storage volume the first medical application occupies, the estimated execution duration the first medical application requires, and/or the computing capability of the computing device the first medical application demands, respectively, the second criterion may be determined to satisfy the first criterion associated with the first medical application.

In 708, the resource manager 260 (e.g., the allocation module 540) may designate the second computing device as the first computing device. If the second medical application executed by the second computing device is similar to or associated with the first medical application and the second criterion associated with the second computing device satisfies the first criterion associated with the first medical application, the second computing device may be determined as the first computing device. The resource manager 260 may send the request for performing the first medical application to the second computing device. Because the second medical application executed by the second computing device is similar to or associated with the first medical application, the resource manager 260 may allocate the second computing device to execute the first medical application, which may reduce the data transmission in the process for executing the first medical application, thereof decreasing the network load and improve system efficiency.

In 710, the resource manager 260 (e.g., the allocation module 540) may determine whether there is one or more third computing devices with second criterions satisfying the first criterion associated with the first medical application. In response to the determination that there is one or more third computing devices with second criterions satisfying the first criterion associated with the first medical application, process 700 may proceed to 712; otherwise, process 700 may proceed to 714.

If there is no second medical application executed by a second computing device similar to or associated with the first medical application; or if there is, but the second criterion associated with the second computing device does not satisfy the first criterion associated with the first medical application, the one or more third computing devices with a second criterion satisfying the first criterion associated with the first medical application may be determined from the plurality of computing devices. In some embodiments, the resource manager 260 (e.g., the criterion determination module 530) may determine a second criterion associated with each of the plurality of computing devices as described in connection with operation 640 in FIG. 6. If the free computing resource of a computing device is consistent with (e.g., greater than or equal to) the estimated computing resources that the first medical application demands, the computing device may be determined as a third computing device.

In 712, the resource manager 260 (e.g., the allocation module 540) may designate a third computing device having a maximum free computing resource among the one or more third computing devices as the first computing device. The maximum free computing resource may relate to the free storage volume of the third computing device, the number of processing units (e.g., CPU, GPU, FPGA, etc.) within the third computing device, the time period the computing resources of the second computing device can be occupied, the computing capability of the second computing device, or the like, or a combination thereof. For example, the free computing resource of the third computing device may be defined by a weighted sum of the free storage volume of the third computing device, the number of processing units (e.g., CPU, GPU, FPGA, etc.) within the third computing device, the time period the computing resources of the second computing device can be occupied, the computing capability of the second computing device, or the like, or a combination thereof. The greater the weighted sum is, the greater the free computing resource of the third computing device may be.

The resource manager 260 may send the request for performing the first medical application to the third computing device having the maximum free computing resource among the one or more third computing devices. The third computing device having the maximum free computing resource (i.e., the first computing device) may execute the first medical application based on the request for performing the first medical application as described elsewhere in the present disclosure (e.g., FIG. 6 and the descriptions thereof).

In 714, the resource manager 260 (e.g., the allocation module 540) may determine whether the first medical application can be divided into a plurality of tasks. In response to the determination that the first medical application can be divided into the plurality of tasks, process 700 may proceed to 716; otherwise, process 700 may proceed to 720.

If there is no third computing device with a second criterion satisfying with the first criterion associated with the first medical application, the resource manager 260 may further determine whether the first medical application can be divided into the plurality of tasks. In some embodiments, if the first medical application includes a plurality of sub-applications, the first medical application may be divided into the plurality of tasks. Each of the plurality of tasks may correspond to one of the plurality of sub-applications. There may be an associating relationship between two of the plurality of sub-applications as described elsewhere in the present disclosure. For example, the raw data of a first sub-application may be the result of a second sub-application. For a further example, an image post-processing application may include an image denoising sub-application, an image enhancement sub-application, an image segmentation sub-application, etc. As still example, a virtual reality application may include an image reconstruction sub-application, a volume rendering sub-application, etc.

In some embodiments, if the computing process for executing the first medical application is continuous, and/or the first medical application does not include a plurality of sub-applications, the first medical application cannot be divided into a plurality of tasks. For example, a template calculation in a volume rendering application, a Fourier calculation in an MR image reconstruction application, such kinds of applications cannot be divided into a plurality of tasks.

In 716, the resource manager 260 (e.g., the allocation module 540) may divide the first medical application into the plurality of tasks. In some embodiments, the resource manager 260 (e.g., the criterion determination module 530) may further determine a third criterion associated with each of the plurality of tasks. The third criterion associated with a task may indicate an estimated computing resource that the task demands. The third criterion associated with a task may be determined as described in connection with operation 630.

In 718, the resource manager 260 (e.g., the allocation module 540) may allocate at least one of the plurality of computing devices to execute the plurality of tasks. In some embodiments, the resource manager 260 may allocate a single one of the plurality of computing devices to execute the plurality of tasks. The free computing resource of the single one of the plurality of computing devices may satisfy the maximum estimated computing resource associated with one of the plurality of tasks. In some embodiments, the resource manager 260 may allocate one portion of the plurality of computing devices to execute the plurality of tasks. Each of the plurality of tasks may correspond to one of the plurality of computing devices. The second criterion associated with a computing device may satisfy the third criterion associated with a corresponding task. In other words, the computing device may have a free computing resource satisfying estimated computing resource associated with the corresponding task. In some embodiments, the resource manager 260 may send a computing protocol (e.g., algorithms for executing the plurality of tasks) corresponding to each of the plurality of tasks to the at least one of the plurality of computing devices for performing the first medical application.

In 720, the resource manager 260 (e.g., the allocation module 540) may determine a third medical application allocated to a fourth computing device. In some embodiments, the third medical application may queue to wait to be executed by the fourth computing device. In some embodiments, the fourth computing device may being executing the third medical application. One portion of the computing resource of the fourth computing device may be recorded and/or reserved for the third medical application. The priority of the third medical application may be lower than the priority of the first medical application. The priorities of the third medical application and the first medical application may be determined by the resource manager 260 (e.g., the acquisition module 510) with reference to operation 610 as illustrated in FIG. 6. When there is no third computing device to execute the first medical application and the first medical application cannot be divided, the third medical application allocated to the fourth computing device may be determined. The computing resource of the fourth computing device reserved for or occupied by the third medical application may be released by stopping executing the third medical application.

In 722, the resource manager 260 (e.g., the allocation module 540) may release computing resource of the fourth computing device reserved for or occupied by the third medical application. For example, the third medical application may be an image post-processing application. The first medical application may be a volume rendering application. An image post-processing application may have a relatively lower priority than a volume rendering application because such medical applications do not require short response time. When there is a competition for computing resources, such medical applications (e.g., an image post-processing application) having lower priorities may be paused or queue for allocation. The resource manager 260 may then release the computing resource of the fourth computing device reserved for or occupied by the third medical application (e.g., an image post-processing application) so that enough free computing resource becomes available in the fourth computing device to execute the first medical application (e.g., a volume rendering application).

In 724, the resource manager 260 (e.g., the allocation module 540) may designate the fourth computing device as the first computing device. If the second criterion associated with the fourth computing device satisfies the first criterion associated with the first medical application after the fourth computing device releases the computing resource reserved for or occupied by the third medical application (e.g., the free computing resource of the fourth computing device is consistent with the estimated computing resources that the first medical application demands), the fourth computing device may be designated as the first computing device. The resource manager 260 may send the request for performing the first medical application to the fourth computing device (i.e., the first computing device). In some embodiments, the request for performing the first medical application may include a computing protocol as described elsewhere in the present disclosure (e.g., FIG. 6 and the descriptions thereof).

In some embodiments, the resource manager 260 may reserve and/or record one portion of the computing resource of an allocated computing device for the first medical application or one or more tasks divided from the first medical application. The one portion of the computing resource of the allocated computing device may satisfy the estimated computing resource that the first medical application or the one or more tasks divided from the first medical application demand(s). The resource manager 260 may release the one portion of the computing resource of the allocated computing device when the allocated computing device finishes executing the first medical application or the one or more tasks so that the allocated computing device may have sufficient free computing resource to execute the first medical application or the one or more tasks.

In some embodiments, after allocating the first medical application or the one or more tasks to a computing device, the resource manager 260 may identify the free computing resource of the computing device based on the estimated computing resource that the first medical application or the one or more tasks demand(s) and/or the one portion of the computing resource of the computing device reserved for executing the first medical application or the one or more tasks. The identified free computing resource of the computing device may include computing resource except the estimated computing resource that the first medical application or the one or more tasks demand(s) and/or the one portion of the computing resources of the first computing device reserved for executing the first medical application or the one or more tasks. The resource manager 260 may then record the identified free computing resource of the computing device for allocating to another medical application.

In some embodiments, after the computing device finishes executing the first medical application or the one or more tasks, the estimated computing resource that the first medical application or the one or more tasks demand(s) and/or the one portion of the computing resource of the computing device reserved for executing the first medical application or the one or more tasks may be released and become available to be allocated to another medical application or a portion thereof. The resource manager 260 may identify and update free computing resource of the computing device based on the estimated computing resource that the first medical application or the one or more tasks demand(s) and/or the one portion of the computing resource of the first computing device reserved for executing the first medical application or the one or more tasks. The identified free computing resource of the computing device may be increased by adding the estimated computing resource that the first medical application or the one or more tasks demand(s) and/or the one portion of the computing resource of the first computing device reserved for executing the first medical application or the one or more tasks into the identified free computing resource. The resource manager 260 may further record the identified free computing resource of the computing device for allocating to another medical application.

It should be noted that the above description of the process of allocating computing resources for medical applications in response to requests for performing the medical applications is merely provided for the purposes of illustration, and not intended to limit the scope of the present disclosure. For persons having ordinary skills in the art, multiple variations and modifications may be made under the teachings of the present disclosure. Such variations and modifications do not depart from the scope of the present disclosure. For example, process 700 may further include an operation in which free computing resources of each of the plurality of computing devices may be updated at time intervals (e.g., 0.05 s). As another example, process 700 may terminate at 706 and does not proceed to node A and perform at least some of operations starting from node A as illustrated in FIG. 7B.

FIGS. 8A-8E are schematic diagrams illustrating exemplary processes for one or more computing devices executing one or more medical applications according to some embodiments of the present disclosure. A computing device (e.g., the computing device 240-1) may be allocated by a resource manager (e.g., the resource manager 260) to execute a medical application (also referred to as a task) as described elsewhere in the present disclosure (e.g., FIGS. 6, 7A, and 7B and the descriptions thereof). The computing device may include one or more algorithm modules and one or more computing cards. An algorithm module may be configured to provide one or more algorithms for the one or more computing cards. For example, exemplary algorithms may include an image reconstruction algorithm, a volume rendering algorithm, an image post-processing algorithm, a machine learning algorithm, or the like, or any combination thereof. Algorithms embedded in an algorithm module may be same as or different from that embedded in other algorithm modules. A computing card may include one or more processors, a memory, an onboard storage device, a port or connector, etc. For example, the computing card may include a video card, Xeon Phi computing card, a computing card with an FPGA, or any other computing card with a PCI-E interface. The computing card may be a portable computing device that can be inserted into, plugged into, or connected to multiple different types of host computing devices as illustrated in FIG. 2A.

As shown in FIG. 8A, a computing device 810 may be a single process structure that can execute one single task at the same time. The computing device 810 may include an algorithm model 1, an algorithm module 2, a computing card 1, and a computing card 2. The computing device 810 may receive a task A after a resource manager (e.g., the resource manager 260) identifies the computing device from a plurality of computing devices and allocates the computing device to execute a medical application, also referred to as a task A. Only one of the computing card 1 or the computing card 2 may be recruited to execute the task A using algorithms obtained from the algorithm module 1 and the algorithm module 2.

As shown in FIG. 8B, a computing device 820 may be a single process structure that can execute one single task at the same time. The difference between the computing device 820 shown in FIG. 8B and the computing device 810 shown in FIG. 8A is that a computing card 1 and a computing card 2 of the computing device 820 may be both recruited to execute the task A using algorithms from the algorithm module 1 and the algorithm module 2. For example, the computing card 1 may execute a sub-task divided from the task A using an algorithm from the algorithm module 1, and the computing card 2 may execute another sub-task divided from the task A using an algorithm from the algorithm module 2.

As shown in FIG. 8C, a computing device 830 may be a multi-process structure that can execute multiple tasks (e.g., a task A and a task B) at the same time. The computing device 830 may receive the task A and the task B after a resource manager (e.g., the resource manager 260) identifies the computing device 830 from a plurality of computing devices and allocates the computing device 830 to execute the task A and the task B. Only one of a computing card 1 or a computing card 2 may execute the task A and the task B simultaneously using an algorithm obtained from the algorithm module 1 required by the task A and an algorithm obtained from the algorithm module 2 required by the task B, respectively.

As shown in FIG. 8D, a computing device 840 may be a multi-process structure that can execute multiple tasks (e.g., a task A and a task B) at the same time. The difference between the computing device 840 shown in FIG. 8D and the computing device 830 shown in FIG. 8C is that a computing card 1 and a computing card 2 of the computing device 840 may be recruited simultaneously to execute the task A and task B using algorithms from the algorithm module 1 and the algorithm module 2, respectively. For example, the computing card 1 may execute the task A using an algorithm from the algorithm module 1, and simultaneously the computing card 2 may execute the task B using an algorithm from the algorithm module 2.

As shown in FIG. 8E, multiple tasks (e.g., a task A and a task B) may be executed by multiple computing cards included in different computing devices (e.g., a computing device 850 and a computing device 860). The computing device 850 may receive the task A after a resource manager (e.g., the resource manager 260) identifies the computing device 850 from a plurality of computing devices and allocates the computing device 850 to the task A. The computing device 860 may receive the task B after the resource manager identifies the computing device 860 from the plurality of computing devices and allocates the computing device 860 to the task B. A computing card 1 and a computing card 2 of the computing device 850 may obtain algorithms stored in the algorithm module 1 to execute multiple sub-tasks divided from the task A. One of a computing card 1 or a computing card 2 of the computing device 860 may obtain the algorithms stored in the algorithm module 1 to execute at least one of the multiple sub-tasks divided from the task A through a message passing interface (MPI) based remote direct memory access (RDMA) protocol. One of the computing card 1 or a computing card 2 of the computing device 860 may obtain the algorithms stored in the algorithm module 1 and/or the algorithm module 2 to execute the task B simultaneously.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

We claim:

1. A system for allocating computing resources for medical applications in response to requests for the medical applications received by interacting with at least one client terminal via a user interface, the system comprising:
a plurality of computing devices, each of the plurality of computing devices including at least one processor;
a network configured to facilitate communication between components in the system;
at least one storage device storing executable instructions; and
one or more resource managers in communication with the plurality of computing devices and the at least one storage device via the network, when executing the executable instructions, cause the system to
receive the requests for performing the medical applications from the at least one client terminal via the user interface, each of the medical applications having a priority;
identify, from the medical applications, a first medical application whose priority satisfies a condition;
determine a first criterion associated with the first medical application, the first criterion indicating an estimated computing resource that the first medical application demands;
determine a second criterion associated with each of the plurality of computing devices, the second criterion indicating a characteristic of the each of the plurality of computing devices;
identify a first computing device from the plurality of computing devices based on the first criterion and the second criterion; and
allocate the first computing device to execute the first medical application.

2. The system of claim 1, wherein the medical applications include at least one of an image reconstruction application, an image post-processing application, a volume rendering application, a virtual reality application, or an artificial intelligence application.

3. The system of claim 1, wherein the estimated computing resource that the first medical application demands is defined by at least one of an estimated storage volume the first medical application occupies, a type of a computing device executing the first medical application, or a computing capability of the computing device.

4. The system of claim 1, wherein the one or more resource managers are further configured to cause the system to:
reserve one portion of a computing resource of the first computing device for the first medical application, the one portion of the computing resource of the first computing device being greater than or equal to the estimated computing resource that the first medical application demands;
record the one portion of the computing resource of the first computing device allocated to the first medical application; and
release the one portion of the computing resource of the first computing device when the first computing device finishes executing the first medical application.

5. The system of claim 1, wherein the one or more resource managers are further configured to cause the system to:
identify a free computing resource of the first computing device based on the estimated computing resource that the first medical application demands and/or the portion of the computing resource of the first computing device reserved for the first medical application; and
record the identified free computing resource.

6. The system of claim 1, wherein to identify a first computing device from the plurality of computing devices, the one or more resource managers are further configured to cause the system to:
determine the first computing device from the plurality of computing devices by determining whether the first medical application is similar to or associated with a second medical application executed by a second computing device.

7. The system of claim 6, wherein to determine the first computing device from the plurality of computing devices by determining whether the first medical application is associated with a second medical application executed by a second computing device, the one or more resource managers are further configured to cause the system to:
determine that the first medical application is similar to or associated with the second medical application;
determine that the second criterion of the second computing device satisfies the first criterion associated with the first medical application in response to the determination that the first medical application is similar to or associated with the second medical application; and
designate the second computing device as the first computing device in response to a determination that the second criterion of the second computing device satisfies the first criterion associated with the first medical application.

8. The system of claim 6, wherein to determine the first computing device from the plurality of computing devices based on the determination by determining whether the first medical application is associated with a second medical application executed by a second computing device, the one or more resource managers are further configured to cause the system to:
determine that the first medical application is not similar to or associated with the second medical application;
identify one or more third computing devices from the plurality of computing devices, the second criterion of each of the one or more third computing devices satisfying the first criterion associated with the first medical application; and
designate a third computing device having a maximum free computing resource among the one or more third computing devices as the first computing device.

9. The system of claim 1, wherein to determine a first computing device from the plurality of computing devices based on the first criterion and the second criterion, the one or more resource managers are further configured to cause the system to:
determine that the second criterion of the each of the plurality of computing devices does not satisfy the first criterion associated with the first medical application; and
determine a third medical application allocated to a fourth computing device, a priority of the third medical application being lower than the priority of the first medical application;
release a computing resource of the fourth computing device reserved for or occupied by the third medical application; and
designate the fourth computing device as the first computing device.

10. The system of claim 1, wherein to determine a first computing device from the plurality of computing devices based on the first criterion and the second criterion, the one or more resource managers are further configured to cause the system to:
determine that the second criterion of the each of plurality of computing devices does not satisfy the first criterion associated with the first medical application;
divide the first medical application into a plurality of tasks; and
allocate the plurality of tasks to at least one of the plurality of computing devices.

11. The system of claim 1, wherein to identify, from the medical applications, a first medical application whose priority satisfies a condition, the one or more resource managers are further configured to cause the system to:
determine a fourth medical application whose priority is the same as or similar to the first medical application; and
determine that a queue time of the first medical application is longer than that of the fourth medical application or the estimated computing resource of the first medical application is lower than that of the fourth medical application.

12. The system of claim 1, wherein the one or more resource managers are further configured to cause the system to:
cause the first computing device to execute the first medical application to generate a result; and
send the result associated with the first medical application to the at least one client terminal.

13. The system of claim 1, wherein the each of the plurality of computing devices further includes one or more computing cards.

14. The system of claim 1, wherein the one or more resource managers further includes a network load balancer configured to receive and allocate the requests to the one or more resource managers.

15. The system of claim 1, wherein the one or more resource managers are further configured to cause the system to:
receive, via the user interface from the at least one client terminal, one or more characteristics of the first medical application.

16. The system of claim 1, wherein the one or more resource managers are further configured to cause the system to:
provide a notification, via the user interface to the at least one client terminal, that a computing device has been allocated to execute the first medical application.

17. A method for allocating computing resources for medical applications implemented by a computing device, the computing device including at least one processor and at least one storage device, the method comprising:
receiving requests for performing medical applications from at least one client terminal via a user interface, each of the medical applications having a priority;
identifying, from the medical applications, a first medical application whose priority satisfies a condition;
determining a first criterion associated with the first medical application, the first criterion indicating an estimated computing resource that the first medical application demands;
determining a second criterion associated with each of the plurality of computing devices, the second criterion indicating a characteristic of the each of the plurality of computing devices;
identifying a first computing device from the plurality of computing devices based on the first criterion and the second criterion; and
allocating the first computing device to execute the first medical application.

18. A method for allocating computing resources for medical applications implemented by a computing system, the computing system including a plurality of computing nodes, the method comprising:
receiving, by the computing system, one or more requests for performing the medical applications from at least one client terminal via a user interface, each of the medical applications has a priority;
determining, based on a task property of at least one of the medical applications, one or more computing nodes for the at least one of the medical applications whose priority satisfies a condition; and
causing the one or more determined computing nodes to execute the at least one of medical applications.

19. The method of claim 18, wherein the determining one or more computing nodes for at least one of the medical applications comprising:
evaluating an estimated computing resource that the at least one of the medical applications demands based on the task property, the task property including at least one of an estimated storage volume the at least one of the medical applications occupies, a type of the one or more computing nodes executing the at least one of the medical applications, a computing capability of the one or more computing nodes, or a task affinity; and
determining the one or more computing nodes whose computing resource matches with the estimated computing resource.

20. The method of claim 18, wherein the medical applications include at least one of an image reconstruction application, an image post-processing application, a volume rendering application, a virtual reality application, or an artificial intelligence application.
